(19) United States
(12) Patent Application Publication
(10) Pub. No.: US 2023/0010149 A1
(43) Pub. Date: Jan. 12, 2023

(54) VOICE ISOLATION DEVICE

(71) Applicant: Private MONK Inc., Brookline, MA (US)

(72) Inventor: Dan Oren, Brookline, MA (US)

(21) Appl. No.: 17/305,438

(22) Filed: Jul. 7, 2021

(51) Int. Cl. A62B 23/02; A41D 1/00; H04R 3/04; H04R 1/34

(52) U.S. Cl. CPC A62B 23/025; A41D 1/002; H04R 3/04; H04R 1/342; H04R 1/345

(57) ABSTRACT

A face mask can both actively cancel sounds and passively attenuate sounds spoken by the user to prevent the sounds from reaching non-intended recipients positioned near the user. The mask can not only reduce the user's voice from escaping the mask but can also be used to reduce external sounds from reaching inside the mask. Thus, a user can wear the mask in public and talk on their phone without disturbing others around them. The mask can include at least one microphone and at least one audio speaker disposed inside and/or outside the mask. Sounds received by the microphone can be processed by a microphone and computing electronics to provide an output to the audio speaker that can appropriately attenuate the sound received by the microphone, via acoustic cancelation. The mask can not only be used to cancel sounds but may also be used to amplify sounds when desired.

### BACKGROUND OF THE INVENTION

### 1. Field of the Invention

Embodiments of the invention relate generally to privacy devices. More particularly, embodiments of the invention relate to a wearable mask that can provide voice isolation and privacy for a user.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In today's society, technology has made it possible to listen to music, watch movies, and play games privately, everywhere you want, and without distracting others. Yet it is not currently possible to maintain privacy, everywhere you want, such as when making phone calls or engaging in voice related interactions. There is no wearable device enabling private voice interactions. Further, use of voice assistance (speaking into a device rather than typing) is growing year after year, yet 74% of this usage is occurring at home because consumers prefer privacy when speaking to a voice assistant.

Existing technology for both passive isolation (e.g., earplugs) and active cancellation (e.g., active-noise reduction headsets) is mainly geared for use in or around the ears. High quality earplugs routinely achieve 30-40 dB of noise attenuation, while active-noise reduction (ANR) headsets are available with 10-20 dB of reduction.

In view of the foregoing, there is a need for improved devices for voice isolation and user privacy.

### SUMMARY OF THE INVENTION

To address this need, a voice isolation device, in the form of a wearable mask, covers both the mouth and the nose of the user and enables voice calls and voice chats within the mask, while significantly reducing exterior sound through a combination of passive acoustic attenuation and active voice cancellation technology. The ultimate goal is to ‘cancel’ one's own voice to near zero audible exterior sound with crisp clear (studio-like) interior vocal sound, within the constraints of building a device that is realizable, durable, long-lasting (sufficiently powered), and comfortable.

According to aspects of the present invention, the device is not intended as a headset or a device placed over the ear. While the device may communicate with an earpiece, as discussed below for example, such communication is separate from the functionality of the mask. In some embodiments, the device is designed to cover both the mouth and nose of the user, as described in greater detail below.

Embodiments of the present invention provide a sound attenuating face mask comprising a mask body configured to cover a nose and mouth of a user, wherein the mask body includes at least one sound absorbing material and at least one sound reflecting material, the mask body defining an internal space between the mask body and the user when the face mask is worn by the user; at least one microphone configured to receive a sound signal from at least one of (1) within the internal space, and (2) at an exterior of the face mask; at least one internal computing device receiving the sound signal from the microphone, the at least one internal computing device operable to generate an attenuating sound signal configured to attenuate the sound signal via acoustic cancellation from the at least one microphone; and at least one sound generating device operable to output the attenuating sound signal into at least one of (1) within the internal space, and (2) at the exterior of the face mask.

Embodiments of the present invention further provide a method for attenuating a voice sound signal from a user comprises covering a nose and a mouth of the user with a mask body of a face mask, wherein the mask body including at least one sound absorbing material and at least one sound reflecting material, the mask body defining an internal space between the mask body and the user when the face mask is worn by the user; receiving a sound signal with at least one microphone positioned to receive the sound signal from at least one of (1) within the internal space, and (2) at an exterior of the face mask; generating an attenuating sound signal from at least one internal computing device receiving the sound signal from the microphone, the attenuating sound signal configured to attenuate the sound signal from the at least one microphone; and outputting the attenuating sound signal with at least one sound generating device operable into at least one of (1) within the internal space, and (2) at the exterior of the face mask.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a schematic representation of a mask using interior active sound cancelation based on an interior microphone, according to an exemplary embodiment of the present invention;

FIG. 2 illustrates a schematic representation of a mask using exterior active sound cancelation based on an exterior microphone, according to an exemplary embodiment of the present invention;

FIG. 3 illustrates a schematic representation of a mask using interior active sound cancelation based on an external microphone, according to an exemplary embodiment of the present invention;

FIG. 4 illustrates a schematic representation of a mask using exterior active sound cancelation based on an internal microphone, according to an exemplary embodiment of the present invention;

FIG. 5 illustrates a schematic representation of a mask using interior and exterior active sound cancelation, based on both interior and exterior microphones, according to an exemplary embodiment of the present invention;

FIG. 6 illustrates a schematic electronics configuration for respiratory monitoring using the mask according to exemplary embodiments of the present invention;

FIG. 7 illustrates a right side perspective view of a user wearing a mask according to an exemplary embodiment of the present invention;

FIG. 8 illustrates a left side perspective view of a user wearing the mask of FIG. 7;

FIG. 9 illustrates a cross-sectional view of a mask exterior surface usable for passive sound cancelation, according to an exemplary embodiment of the present invention;

FIG. 10 illustrates the cross-sectional view of the mask of FIG. 9, showing passive sound cancelation via reflection from various layers and sound reduction by passing through the layers, according to an exemplary embodiment of the present invention;

FIG. 11 illustrates a pictorial representation of active sound cancelation achievable with the mask according to exemplary embodiments of the present invention;

FIG. 12 illustrates a pictorial representation of active sound amplification achievable with the mask according to exemplary embodiments of the present invention;

FIG. 13 illustrates a schematic representation of an adjustable sound filter using an adaptive algorithm to adjust active sound cancelation; and

FIG. 14 illustrates a schematic representation of an adjustable sound filter using an adaptive filter with filtered-X LMS algorithm

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a face mask that can both actively cancel sounds and passively attenuate sounds spoken by the user, preventing the sounds from reaching non-intended recipients positioned near the user. The mask can not only reduce the user's voice from escaping the mask but can also be used to reduce external sounds from reaching inside the mask. Thus, a user can wear the mask in public and talk on their phone without disturbing others around them. The mask can include at least one microphone and at least one audio speaker disposed inside and/or outside the mask. Sounds received by the microphone can be processed by a microphone and computing electronics to provide an output to the audio speaker that can appropriately attenuate the sound received by the microphone, via acoustic cancelation. The mask can not only be used to cancel sounds but may also be used to amplify sounds when desired.

The mask can be constructed of highly attenuating and acoustic reflecting materials to maximize internal isolation. The mask can further be outfitted with internal sensors and actively driven internal and/or external speakers for sound cancellation. Advanced signal processing techniques can be employed to drive the audio speaker(s) with a carefully constructed out-of-phase signal. Adaptive learning methods can be embedded to optimize cancellation for each user, accounting for differences in vocal spectrum, mask fit, and other personal variations.

In some embodiments, approximately 50 dB of total sound reduction can be achieved between the active and passive elements, reducing the spoken word from a typical 65 dB down to 15 dB, or the level of a whisper. In addition, internal sensors can be used to monitor breath metrics and vocal variability to provide actionable biofeedback.

Conventional active noise reduction (ANR) is typically designed to reduce broadband low-frequency noise, while allowing tonal signals (e.g., voices) to pass through. The low frequency focus (typically <300 Hz) is further accentuated by the physics of sound cancellation, enabling easier cancellation at lower frequencies, where the wavelengths are longer.

According to embodiments of the present invention, active voice cancellation (AVC) technology can be used to target the predominant frequencies of voice, which is generally between 100 Hz-2 kHz. Although somewhat age dependent, the fundamental frequency of human speech is around 100 Hz for males and 200 Hz for females, with multiple harmonics of each at higher frequencies. Most of the acoustic energy resides in the fundamental and first few harmonics, thus targeting this frequency range is most effective for overall sound reduction. The mask of the present invention can employ attenuating materials to passively reduce sound, which is most effective at higher frequencies, combined with active voice cancellation, which is most effective at lower frequencies. Thus, a sufficient attenuation bandwidth can be achieved when combining the active and passive features of the present invention.

With certain embodiments of the mask of the present invention, unlike most sound cancellation applications, there is no need to separate speech from noise, as the goal is to cancel all perceived sound. Typically, sound cancellation is focused solely on removing noise from the signal, leaving the speech behind, but in embodiments of the present invention, all sound is desired to be removed. That means that it is not necessary to identify the signal from the noise and perform cancellation on only the noise. This greatly reduces the processing burden.

The resulting product can provide high-impact benefits to both consumer and business users, enabling vocal privacy to augment existing video and audio privacy.

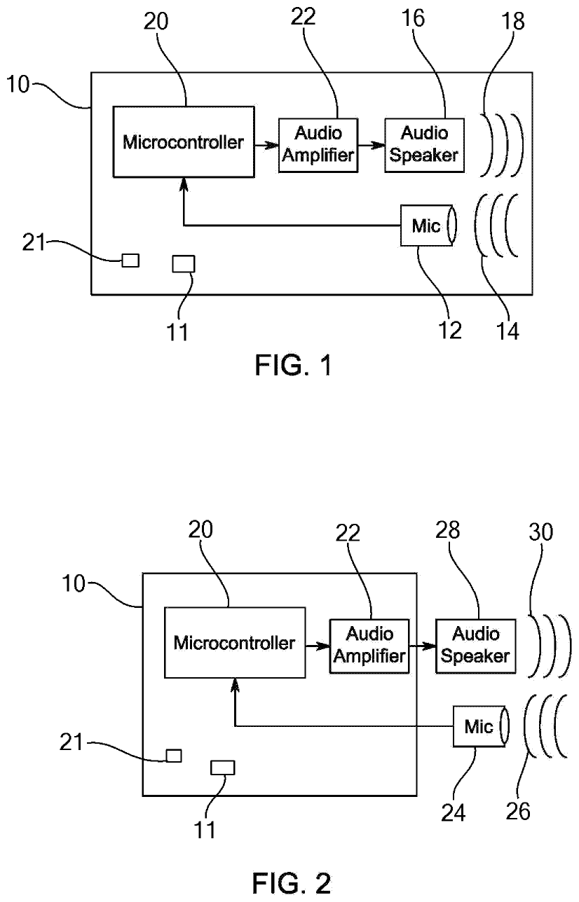

Referring now to FIGS. 1 through 5, a mask 10 is represented schematically with various configurations for the electronics for active voice cancellation. In each embodiment, a microphone can be provided, either as an internal microphone 12, as an external microphone 24, or as both internal and external microphones 12, 24. Similarly, an audio speaker can be provided, either as an internal audio speaker 16, as an external audio speaker 28, or as both internal and external audio speakers 16, 28. Other sound producing devices may be used in place of, or in addition to, the audio speaker. Such sound producing devices can include other audio transducers/actuators, such as a contact speaker. As discussed in greater detail below, sound received by a microphone (such as microphones 12, 24) can be processed by an internal computing device, such as a digital signal processing (DSP) chip or a microprocessor 20, amplified appropriately by an audio amplifier 22 and outputted to one or more speakers, such as audio speakers 16, 28.

As shown in FIG. 1, in some embodiments, active voice cancellation can be achieved completely internal to the mask 10, where a microphone 12 can receive sound waves 14 and the audio speaker 16 can generate sound waves 18 that can cancel the user's voice (which are included in the sound waves 14) inside the mask 10. By reducing the decibel level of the user's voice inside the mask, less sound reaches the outside of the mask 10.

As shown in FIG. 2, in some embodiments, active voice cancellation can be achieved completely external to the mask 10, where a microphone 24 can receive sound waves 26 and the audio speaker 28 can generate sound waves 30 that can cancel the user's voice (which are included in the sound waves 24) outside the mask 10. This embodiment can help cancel the portion of the user's voice that makes it outside of the mask 10.

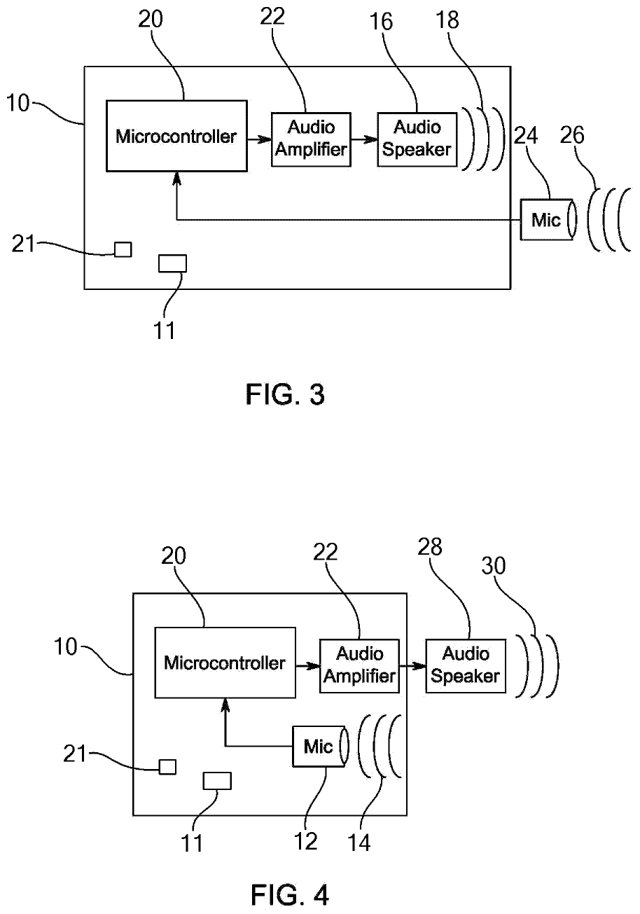

As shown in FIG. 3, in some embodiments, active voice cancellation can be achieved by listening, via the microphone 24, to sound waves 26 outside the mask 10 to provide a cancellation signal to be outputted as sound waves 18 from the audio speaker 16 inside the mask. This embodiment can help reduce the sound of the user's voice inside the mask 10 that would otherwise escape the mask 10. Further, this embodiment can be used to actively cancel sounds from outside the mask 10 from being picked up by microphones (such as microphone 12, if present, or microphone 11, as discussed below) disposed inside the mask 10.

As shown in FIG. 4, in some embodiments, active voice cancellation can be achieved by receiving sound waves 14 from a microphone 12 inside the mask 10 and generating a cancellation signal via sound waves 30 provided by an audio speaker 28 disposed outside of the mask 10.

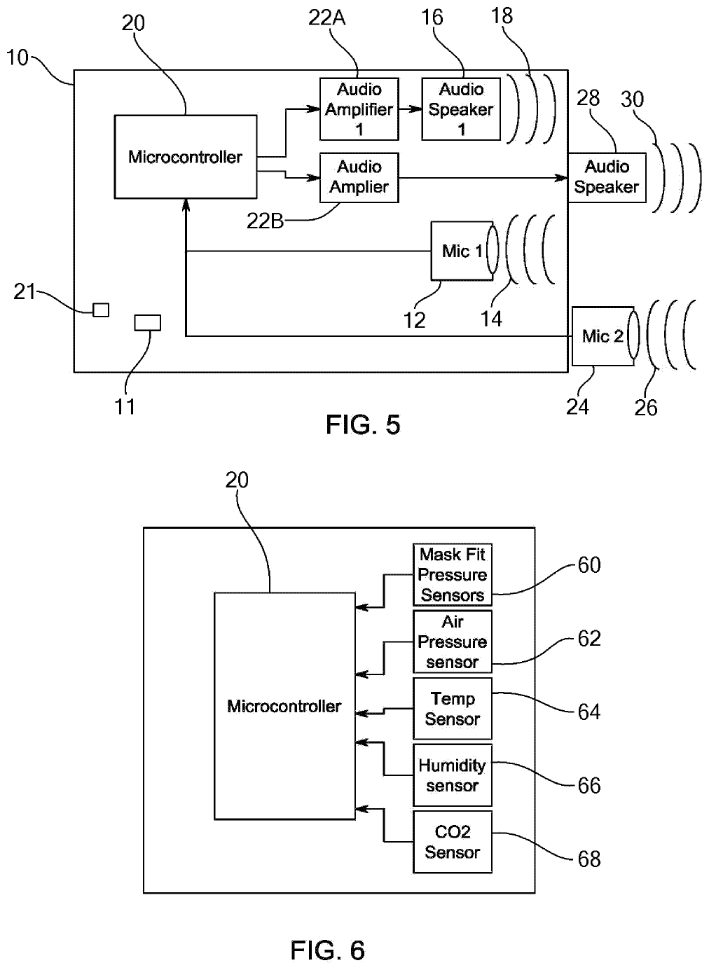

As shown in FIG. 5, in some embodiments, active voice cancellation can be achieved by receiving sound waves 14, 26 both inside and outside the mask via microphones 12, 24. An audio signal can be output via sound waves 18, 30 both inside and outside the mask 10 via audio speakers 16, 28. In this embodiment, active sound cancellation can be performed both on the user's voice inside the mask, as well as on the user's voice that makes it to the outside of the mask. Further, noise outside the mask can be canceled inside the mask via the combination of the external microphone 24 and the internal audio speaker 16. In some embodiments, a first audio amplifier 22A can provide amplification for the internal audio speaker 16 and a second audio amplifier 22B can provide amplification for the external audio speaker 28, thus permitting different cancellation signals (sound waves 18, 30) inside and outside of the mask 10. Further, with the external audio speaker, the user can permit their voice to be transmitted outside the mask, if desired. Such transmission may further include amplification, as desired.

While FIGS. 1 through 5 illustrate exemplary embodiments of the present invention, other configurations are contemplated within the scope of the present invention. For example, the configuration with a single microphone located inside the mask may be used with an audio speaker located both inside and outside of the mask. Similarly, a single audio speaker may be used with a microphone located both inside and outside of the mask.

In each of the embodiments, an optional microphone 11 can be provided for capturing the user's voice for telecommunications. A wireless transceiver 21, such as a Bluetooth® device, can be incorporated into the mask 10. The user's voice 11 can be provided to a communication device, such as a smart phone (not shown) to transmit the user's voice to another during a phone call. In some embodiments, the microphone 11 may not be present and the internal microphone 12 may be used both for sound cancellation, as discussed above, as well as for receiving the voice signal for a phone call or other such communication.

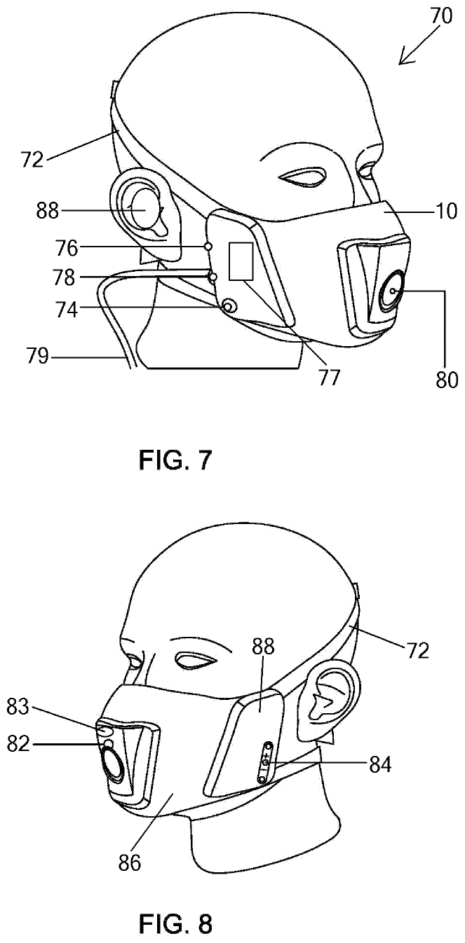

In some embodiments, the wireless transceiver 21 can communicate with an earpiece 88 (see FIG. 7). The earpiece 88 can receive sound, via the wireless transceiver 21 (or via a wireless connection from a telecommunication device), from another, such as from a person the user is speaking with via a phone call. The earpiece 88 can also receive the sound of the user's own voice, as they may not be able to hear themselves while operating the mask 10. In this embodiment, the microphone 11, the internal microphone 12 or even the external microphone 24 may receive the user's voice to deliver the sound to the earpiece 88. The earpiece 88 may be part of the electronics of the mask 10 or may be a stand-alone unit provided by the user. Of course, while the above provides an exemplary embodiment for wireless communication between the microphone elements of the mask, an earpiece and a communication device, other communication protocols, as may be known in the art, may be used to provide the desired interactions between the various components.

In some embodiments, the wireless transceiver 21 can optionally pair with one or more masks of other users, permitting communication between mask wearers.

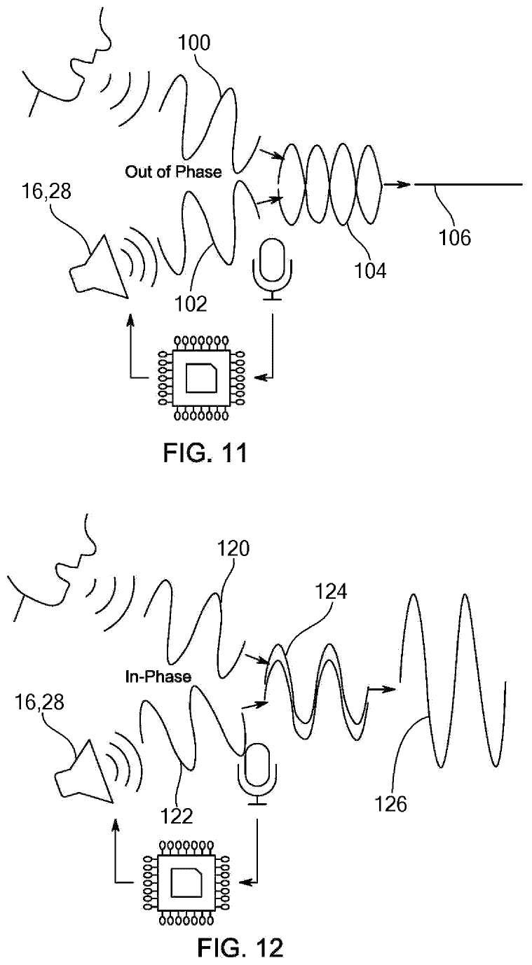

While the above describes sound cancellation, it should be understood that the microcontroller 20 can be programmed to provide an output signal that, instead of cancelling the sound (as shown in FIG. 11), amplifies the sound (as shown in FIG. 12), allowing the user to talk with others while still wearing the mask. In some embodiments, a switch (not shown) can be provided to change modes of the mask between sound cancellation and sound amplification. In some embodiments, the voice amplification mode can provide an opportunity for voice filtering and clean up to remove breath sounds, change voice tone, and improve overall quality. Such voice filtering and clean up can also be provided during telecommunications.

In should be understood that the terms “inside” and “outside” as they relate to the positions of the audio speakers and microphones generally refer to where the microphone can receive sounds or where the audio speakers output sounds. Such terms are not meant to require the speakers and microphones to be physically disposed inside or outside the mask. For example, the external speaker 28 may be disposed on the surface of the mask, with part of the body of the speaker inside the mask. Therefore, such a speaker, may still be described as a speaker “outside the mask” because it provides its output in an environment outside of the mask.

Referring now to FIG. 6, the microcontroller 20 can receive various inputs in order to provide respiratory and/or emotional monitoring. A mask fit pressure sensor 60 can be used to determine the tightness of the fit of the mask on the user. Such information can be used when analyzing breath sounds, taking into account air escape, for example. Further, such information may be useful for providing a variable sound attenuation, as discussed in greater detail below, where a looser fit may signal the microcontroller 20 that more sound may escape the mask and the amount of cancellation can be adjusted accordingly.

An air pressure sensor 62 can be used to measure air pressure inside the mask. Such can provide information not only on mask fit, but also on respiration ability and respiration rate. A temperature sensor 64 can also be provided to help monitor a temperature inside the mask and/or a temperature of the user. A humidity sensor 66 can be used to measure moisture levels in the user's breath, which may provide an advance indicator of heat exhaustion or heat stroke. A carbon dioxide sensor 68 may be used to measure carbon dioxide levels inside the mask, where elevated levels may be indicated to the user. The temperature and humidity sensors can provide further information on respiratory rate and quality.

The biometric monitoring can be used to identify various breath features, such as breath rate, duration of inhalation and expiration, whether the breath is through the nose or mouth or both, and the like.

Further, the microphones can measure vocal variability as an indicator of stress or other emotional states. Combined, the microcontroller 20 can process this data internally, or may send the data to an external device, such as a smart phone, for processing, monitoring, and alerting the user.

Referring to FIGS. 7 and 8, the mask 10 is shown worn by a user 70. As can be seen, the mask 10 is intended to be worn over both the mouth and nose of the user. The mask 10 may be designed to fully or partially seal against the user's face, thus providing an internal volume inside the mask 10. The mask 10 can include straps 72 that may extend around the user's head or may extend about a user's ears. Of course, other methods to attach the mask 10 to the user are contemplated within the scope of the present invention. The mask 10 can include an air filter and exhalation valve 80 that can filter incoming air and provide a one way exhalation valve to permit exhaled air to easily escape the mask 10. In some embodiments, the exhaled air may be filtered by the mask, as well as the inhaled air. In some embodiments, the air filter can be replaceable and may be made of various materials, depending on the level of filtration desired. In some embodiments, a fan (not shown) can be incorporated into the mask, such as part of the air filter and exhalation valve 80. The fan may be used to provide a desired level of ventilation for the mask.

The mask can include a charge port 76, such as a micro-USB port, configured to provide a charge to a rechargeable battery 77 provided as part of the mask 10. The battery 77 may provide power for the microcontroller 20, audio amplifier 22, the wireless transceiver 21, and the like.

An on/off switch 74 may be used to turn the power to the mask on and off. A volume control 84 can be provided to adjust the volume of the signal provided to the phone call recipient, the sound provided to the earpiece 88, or, when in an amplification mode, as discussed above, the amount of amplification of voice provided.

In some embodiments, an oxygen port 78 may be provided to connect an oxygen line 79, where oxygen or oxygen enriched air can be provided to the user via delivery to an internal volume inside the mask.

One or more indicators 82 may be provided, such as a talk light indicator, which can provide an indication to other users that the user wearing the mask is actively speaking, such as being on a phone call or talking with another mask wearer. Such an indicator may be useful because other people around the user wearing the mask may not be able to hear the user that is talking on a phone call.

The mask 10 can also include one or more image sensors 83 located on the outside of the mask to enable digital image capture and live video stream. The image sensors 83 may be connected to the wireless transceiver 21 in order to send the images and/or video to a separate mobile computing device, a cloud server, or the like.

The mask 10 may be made from various base materials 86. Further, electronics and other components may be housed in a separate housing 88, which may be attached to the base material 86 or may be used in place of the base material 86.

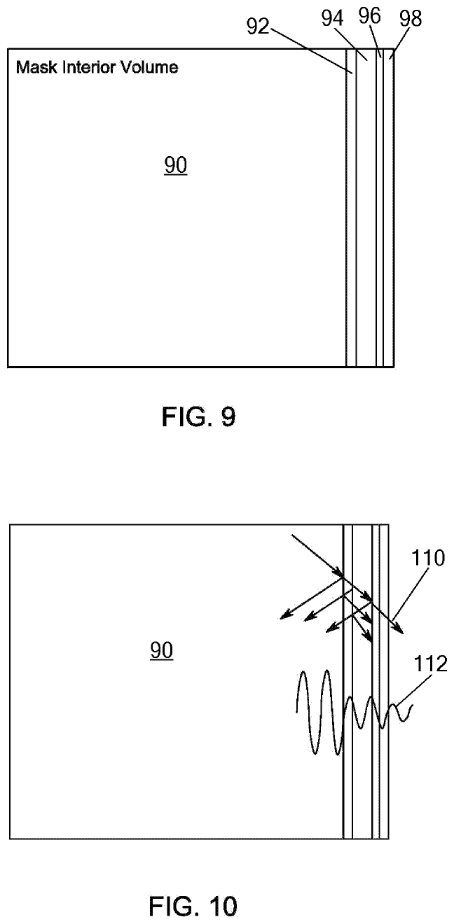

Referring now to FIGS. 9 and 10, passive sound reduction can be achieved with the mask 10 of the present invention. In internal volume 90 of the mask 10 may be where the user's voice is communicated. The mask (such as the base material 86) may be formed in a plurality of layers 92, 94, 96, 98. Each layer may be formed from the same or different material. The material may be selected for sound absorption and sound reflecting properties. Passive attenuation can be achieved through sound absorbent materials inside the mask and acoustically reflective surfaces that reflect some of the sound enabling greater number of passes through the absorbent layers.

The acoustically reflective (acoustically hard) surfaces can be used to contain the sound field and enable more passes through the absorbent materials. The acoustically absorbing materials can line the interior walls of the reflective surfaces. These materials may include open-cell or closed-cell foam, rubbers, cloths, fibers, and viscoelastic materials such that vibration and acoustic waves within them lead to dissipative losses through viscous effects. In some embodiments, the layers 92, 94, 96, 98 can be formed from different materials, each offering various features for the passive sound attenuation. For example, some viscoelastic polymers are designed for sound absorption, such as AcoustiBlok®, and may be employed for additional attenuation. Further, additional viscoelastic polymers may be used at the interface where the mask meets the face to provide further sound reduction by damping the vibration that occurs due to acoustics.

As shown in FIG. 10, the reflective surfaces can limit sound penetration 110, while the absorptive properties can further reduce the sound amplitude 112.

As discussed above, FIG. 11 shows how the spoken sound wave 100 can be combined with an out of phase sound wave 102 from the audio speaker 16, 28 to create a cancellation signal 104 that results in a reduced output 106. In an amplification mode, as shown in FIG. 12, the spoken sound wave 120 can be combined with an in-phase sound wave 102 from the audio speaker 16, 28 to create an amplification signal 124 that results in an amplified output 126.

In some embodiments, the active voice cancellation can be employed in various manners. Typically, active voice cancellation requires measurement of the acoustic field and generation of the appropriate cancellation signal. In one embodiment, the active voice cancellation can identify the signal and generate the cancellation signal waveform using fixed parameters (fixed amplitude and phase compensation). In other embodiments, the active voice cancellation can use adaptive compensation based on actual cancellation performance, as discussed in greater detail below. In still other embodiments, machine learning can be used to generate new or improved adaptive cancellation parameters.

For interior cancellation, the acoustic field can be measured inside the mask that the cancellation signal can be output by the audio speaker. The system can then measure the sound and adjust the parameters of the audio speaker, continuing to use this drive signal until the error signal (that is, the signal from the microphone) approaches zero. This can also help reduce the resonant field arising from reverberation inside the mask.

Exterior cancellation can be performed similarly, where the external microphone (typically on the surface of the mask) can sense what sound has permeated the mask and the audio cancellation signal can be adjusted to reduce this signal toward zero.

The adaptive generation of cancellation fields uses some form of feedback to adapt to the measured sound field. Because each user has a unique vocal spectrum and mask fit, by providing an adaptive generation of the cancellation signal, each user can have the cancellation signal parameters individually adjusted based on various characteristics, such as distance from mouth to mask walls, microphones, and speakers, tightness of mask against face, mouth size, nose size and shape, and facial structure, dynamic spectral content of voice, speed, volume, and dynamic characteristics of voice, and microphone, speaker sensitivity and inherent phase delays, for example. Adaptive cancellation can sense the unique characteristics of the environment and generates the optimum signal for cancellation in that environment. The system can sense the initial acoustic field and generate cancellation field using fixed cancellation parameters. In some embodiments, the system can sense the acoustic field after cancellation and fine-tune, or adapt, parameters based on actual performance. In still other embodiments, the system can learn from adaptive performance to develop new adaptive methods.

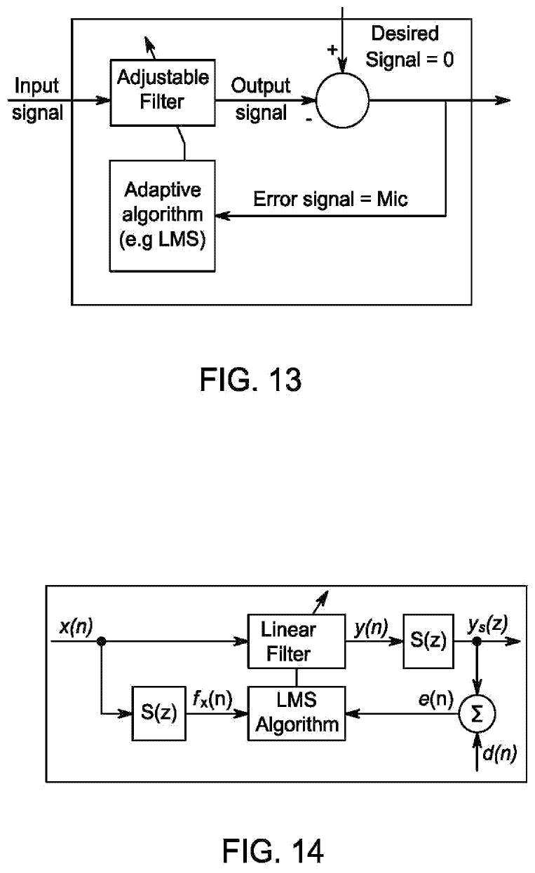

Various adaptive cancellation algorithms and filters can be used. For example, FIGS. 13 and 14 illustrate the use of a least mean squares (LMS) algorithm. The LMS algorithm is an adaptive filter that seeks to minimize the total sound within the mask by finding digital signal processing (DSP) filter coefficients that relate to producing the least mean square of the error signal (difference between the desired and the actual signal). In this application, the desired signal is zero, while the actual signal is the currently measured acoustic field inside the mask.

The LMS algorithm may be augmented through one or more LMS-type variants, such as normalized LMS (NLMS), sign-error LMS, sign-data LMS, sign-sign LMS, or Filtered-X LMS. These each offer tradeoffs in terms of performance, speed, and robustness. Other variants of LMS beside those above may be employed for improved performance under certain conditions. A recursive least square (RLS) algorithm may also be employed in place of the LMS algorithm for adaptively generating the cancellation field. The RLS is most useful when problems of slow convergence arise with the LMS approach. RLS employs a recursive method to find the filter coefficients that minimize a least square cost function.

In some embodiments, the mask can employ various machine learning techniques to further improve the voice privacy performance, specifically through improved active sound cancellation. These methods include various neural network (NN) based approaches such adaptive neural fuzzy filters (ANFF), modified dynamic fuzzy neural network (MDFNN), and enhanced dynamic fuzzy neural network (EDFNN), are more generally many forms of spiking neural networks. Aside from NN type approaches, other methods of machine learning can be used to train systems to recognize performance and provide adjustments to improve cancellation.

In some embodiments, the mask may provide shaped sound fields through the steering of sound fields through phased array methods (using multiple speakers with defined phase relationships). Steering can be used to cancel in select locations while allowing other locations to remain uncancelled or even be amplified. This can be useful to be efficient about cancelling only where it is needed, for instance after locating another person. This can also be useful to amplify in a particular direction to enable longer distance transmission over a focused region.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A sound attenuating face mask comprising:
a mask body configured to cover a nose and mouth of a user, wherein the mask body includes at least one sound absorbing material and at least one sound reflecting material, the mask body defining an internal space between the mask body and the user when the face mask is worn by the user;
at least one microphone configured to receive a sound signal from at least one of (1) within the internal space, and (2) at an exterior of the face mask;
at least one internal computing device receiving the sound signal from the microphone, the at least one internal computing device operable to generate a canceling sound signal configured to attenuate the sound signal from the at least one microphone; and
at least one sound generating device operable to output the canceling sound signal into at least one of (1) within the internal space, and (2) at the exterior of the face mask.

2. The sound attenuating face mask of claim 1, further comprising an audio amplifier operable to amplify the attenuating sound signal to output an amplified canceling sound signal from the at least one sound generating device.

3. The sound attenuating face mask of claim 1, wherein the canceling sound signal is a sound wave that is at least partially out of phase with the sound signal received by the at least one microphone, wherein the canceling sound signal decreases a decibel level of an audible signal at the exterior of the mask.

4. The sound attenuating face mask of claim 1, wherein the canceling sound signal is a sound wave that is at least partially in phase with the sound signal received by the at least one microphone, wherein the canceling sound signal increases a decibel level of an audible signal at the exterior of the mask.

5. The sound attenuating face mask of claim 1, wherein the at least one microphone includes an internal microphone receiving the sound signal from within the internal space.

6. The sound attenuating face mask of claim 5, wherein the at least one sound generating device includes an internal sound generating device outputting the canceling sound signal within the internal space.

7. The sound attenuating face mask of claim 5, wherein the at least one sound generating device includes an external sound generating device outputting the canceling sound signal at the exterior of the face mask.

8. The sound attenuating face mask of claim 5, wherein the at least one sound generating device includes an internal sound generating device outputting the canceling sound signal within the internal space and an external sound generating device outputting the attenuating sound signal at the exterior of the face mask.

9. The sound attenuating face mask of claim 1, wherein the at least one microphone includes an external microphone receiving the sound signal from the exterior of the face mask.

10. The sound attenuating face mask of claim 9, wherein the at least one sound generating device includes an internal sound generating device outputting the canceling sound signal within the internal space.

11. The sound attenuating face mask of claim 9, wherein the at least one sound generating device includes an external sound generating device outputting the canceling sound signal at the exterior of the face mask.

12. The sound attenuating face mask of claim 9, wherein the at least one sound generating device includes an internal sound generating device outputting the canceling sound signal within the internal space and an external sound generating device outputting the attenuating sound signal at the exterior of the face mask.

13. The sound attenuating face mask of claim 1, wherein the at least one microphone includes an internal microphone and an external microphone, and the sound signal includes an internal sound signal from within the internal space and an external sound signal from the exterior of the face mask.

14. The sound attenuating face mask of claim 13, wherein the at least one sound generating device includes an internal sound generating device outputting the canceling sound signal within the internal space and an external sound generating device outputting the canceling sound signal at the exterior of the face mask.

15. The sound attenuating face mask of claim 1, further comprising a plurality of respiratory monitoring sensors providing data to the internal computing device.

16. The sound attenuating face mask of claim 15, wherein the respiratory monitoring sensors include at least one of a pressure sensor, a humidity sensor and a temperature sensor.

17. The sound attenuating face mask of claim 1, further comprising an air filter and exhalation valve providing air communication between the internal space and the exterior of the face mask.

18. The sound attenuating face mask of claim 1, wherein the internal computing device applies an adaptive algorithm to the sound signal to provide the canceling sound signal that is adapted to characteristics of a voice of a user.

19. The sound attenuating face mask of claim 1, further comprising using a machine learning algorithm to teach face mask parameters for sound attenuation.

20. The sound attenuating face mask of claim 1, further comprising a wireless transceiver operable to send the sound signal to an external computing device.

21. The sound attenuating face mask of claim 1, wherein the at least one sound generating device is at least one of an audio speaker or a surface transducer outputting the canceling sound signal via mechanical vibrations of the face mask.

22. A method for attenuating a voice sound signal from a user, the method comprising:
covering a nose and a mouth of the user with a mask body of a face mask, wherein the mask body including at least one sound absorbing material and at least one sound reflecting material, the mask body defining an internal space between the mask body and the user when the face mask is worn by the user;
receiving a sound signal with at least one microphone positioned to receive the sound signal from at least one of (1) within the internal space, and (2) at an exterior of the face mask;
generating an attenuating sound signal from at least one internal computing device microcontroller receiving the sound signal from the microphone, the canceling sound signal configured to attenuate the sound signal from the at least one microphone; and
outputting the attenuating sound signal with at least one sound generating device operable into at least one of (1) within the internal space, and (2) at the exterior of the face mask.
